(19) United States
(12) Patent Application Publication
(10) Pub. No.: US 2008/0055040 A1
(43) Pub. Date: Mar. 6, 2008

(54) PASSIVE DISARMING TRANSCEIVER FOR SECURITY SYSTEMS

(75) Inventors: Alfred M. Lizza, Oyster Bay, NY (US); Dan Tyroler, Great Neck, NY (US); Kenneth G. Eskildsen, Great Neck, NY (US)

Correspondence Address: ANTHONY R. BARKUME, 20 GATEWAY LANE, MANORVILLE, NY, 11949, US

(73) Assignee: HONEYWELL INTERNATIONAL INC., Morristown, NJ (US)

(21) Appl. No.: 11/846,173

(22) Filed: Aug. 28, 2007

Related U.S. Application Data
(60) Provisional application No. 60/841,149, filed on Aug. 29, 2006.

(51) Int. Cl. G05B 19/00

(52) U.S. Cl. 340/5.7

(57) ABSTRACT

A method of disarming an alarm system in a premises by detecting motion of at least part of a door in the premises to trigger generation of a challenge signal; transmitting the challenge signal; receiving a response signal from an associated disarm device such as a keyfob; determining if the response signal is valid as having been generated by an authorized disarm device; and if the response signal is valid, then transmitting a disarm message effective to cause the alarm system to become disarmed.

### CROSS-REFERENCE TO RELATED APPLICATIONS

This application claims priority from co-pending U.S. provisional application Ser. No. 60/841,149, filed on Aug. 29, 2006.

### TECHNICAL FIELD

The present invention relates to passive and automatic disarming of alarm systems, and in particular to a system and method for passively disarming an alarm system with a wireless transceiver that securely interacts with a disarm device triggered by an event such as vibration or movement of an entrance door or the associated with the unlocking of the door.

### BACKGROUND ART

A common cause of false alarms in security systems that monitor a premises is the failure to properly and timely disarm the system. For example, a homeowner may forget how to disarm the security system as he or she enters the door of the premises, or may be distracted from disarming it in time, etc. The result of this is the generation of a false alarm that must be attended to by the central station monitor.

Thus, the present invention provides for the passive and automatic disarming of a security system by an authorized person as a result of vibration or motion of the door or the opening of a door lock.

### DISCLOSURE OF THE INVENTION

The present invention is a device for passively disarming an alarm system, having two main components: a portable wireless disarm device and a door-mounted controller. The door-mounted controller includes a door motion detector that generates a trigger signal on detecting motion or vibration of a lock or door to which the door-mounted controller is mounted, and a processing unit coupled to the door motion detector. The processing unit wirelessly transmits a challenge signal as a result of the trigger signal from the door motion detector, and then receives a response signal from the portable wireless disarm device which may be embedded in a keyfob. The processing unit then determines if the response signal is valid, and, if it is valid, it generates and transmits a disarm message effective to cause the alarm system to become disarmed.

If the response signal is not valid (meaning that the keyfob is not authorized to disarm that alarm system, the processing unit may be further adapted to generate and transmit an alarm message effective to cause the alarm system to generate an alarm. In addition, if no valid response signal is received after a predetermined time has elapsed after the door motion trigger, the processing unit may be further adapted to transmit an alarm message effective to cause the alarm system to generate an alarm.

The door motion detector may for example be an accelerometer, a door contact switch, or a lock position detector.

The processing unit may determine if the response signal from the wireless keyfob is valid by extracting response data from the response signal, comparing the extracted response data with at least one entry in a previously stored lookup table, and declaring the response signal to be valid if the extracted response data matches at least one entry in the previously stored lookup table. Alternatively, the processing unit may determine if the response signal is valid by extracting response data from the response signal, then performing an algorithm on the extracted response data to generate an algorithm result; and declaring the response signal to be valid if the algorithm result is true based on an expected result.

In an alternative embodiment, a proximity sensor (e.g. magnetic field) may be used instead of a motion-based trigger.

### BRIEF DESCRIPTION OF THE DRAWING

FIG. 1 is a block diagram of a preferred embodiment of the present invention.

FIG. 2 is a detailed block diagram of the preferred embodiment of the present invention.

FIG. 3 is a flowchart of the basic operation of the preferred embodiment of the present invention.

### BEST MODE FOR CARRYING OUT THE INVENTION

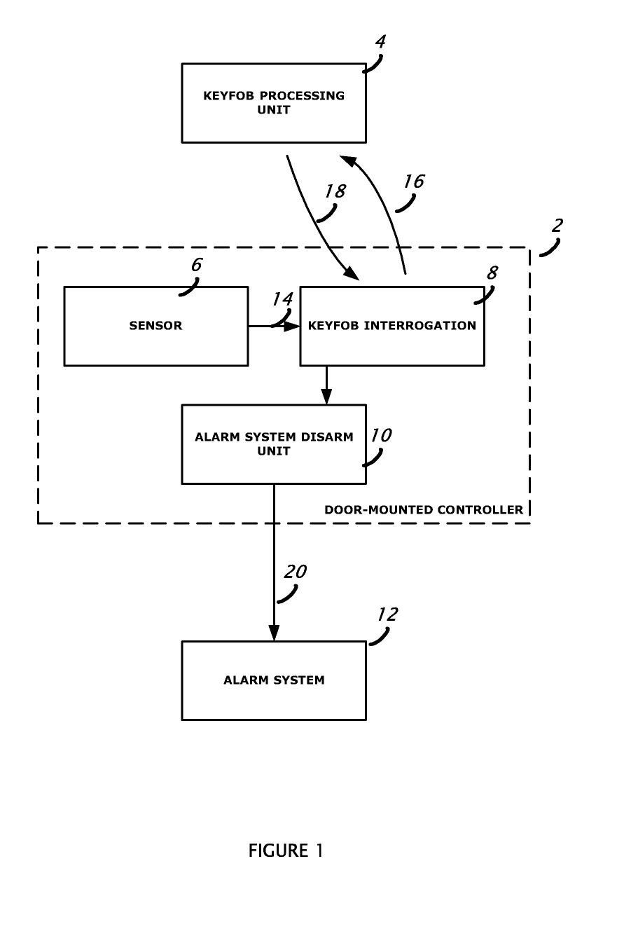

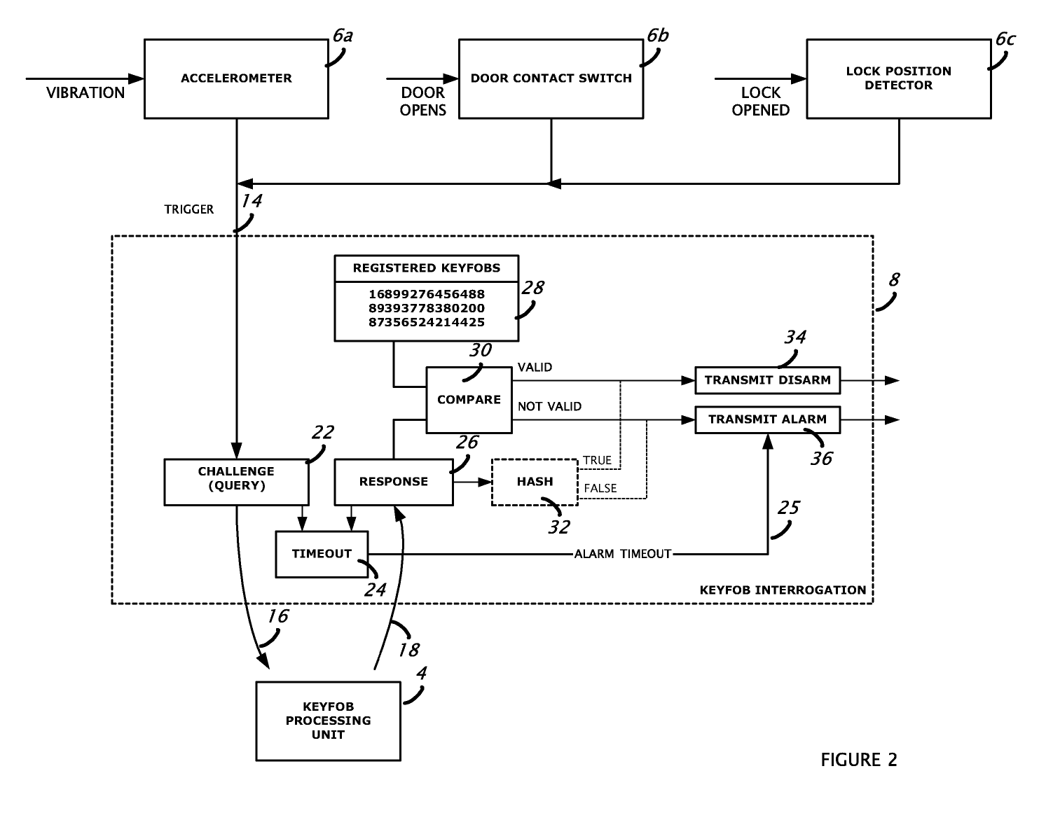

In the present invention, as shown in FIG. 1, two main components are utilized; a door-mounted controller 2 and a wireless keyfob processing unit 4. The wireless processing unit 4 will be provided in a small housing or keyfob that may be attached to a keychain, or it may be integrated with an existing device such as a wireless automobile device, or it may be attached to the key itself, etc. In any event the keyfob processing unit 4 will be carried by an authorized user such as a homeowner or someone granted authority to enter the premises (who would be given the keyfob processing unit by the homeowner along with the key to the door lock). The door mounted controller 2 has three main components as shown in FIG. 1; a sensor 6, an interrogation unit 8, and an alarm system disarm unit 10. The sensor 6 may be an accelerometer 6a, a door contact switch 6b, or a lock position detector 6c as shown in FIG. 2. In an alternative embodiment it may also be a proximity sensor that operates with the keyfob processing unit 4. The sensor 6 will in the preferred embodiment be an magnetic-field sensor 6a capable of detecting a change in the position of the door (as it is opened) by detecting a change in the magnetic field of the earth, or alternatively an accelerometer that will detect a change in position with respect to the gravitational field of the earth. Devices that can sense the change in position in these manners are described more fully in U.S. Pat. No. 6,724,316, METHOD AND APPARATUS FOR DETECTION OF MOTION WITH A GRAVITATIONAL FIELD DETECTOR IN A SECURITY SYSTEM, owned by the assignee of this application and incorporated by reference herein. Alternatively, the sensor 6a may be capable of by detecting vibration of the door such as when the user places the key in the lock and turns it.

The sensor 6 may also be a lock position detector 6c juxtaposed with respect to the door lock to detect when it has been opened such as by a key inserted into the lock and turned. In this embodiment, the sensor may be any of several types of sensors, such as a magnetic reed switch, a contact switch, etc. For example, U.S. Pat. No. 6,963,280, DOOR SECURITY DEVICE FOR USE IN SECURITY SYSTEMS, which is owned by the assignee of this application (Honeywell International Inc.), and which is incorporated by reference herein, describes a device that is suitable for mounting within a recess of a doorjamb or within the door itself. The device of the '280 patent has a lock position detecting switch, adapted to detect the position of a lock mounted on a door as being either locked or unlocked. This is described in a preferred embodiment as a mechanical contact switch that is well known in the art and that can sense the presence of the bolt within the housing (i.e. detect if the lock is locked or unlocked). The housing receives the bolt as it is extended by operation of the locking mechanism on the door into the locked position. When the bolt is in the locked, or extended, position, then the arm on the contact switch is caused to close, and a DOOR LOCKED signal is generated by the contact switch and input to the processor. When, however, the bolt is retracted into the door, then the arm opens and the DOOR LOCKED signal changes state to DOOR UNLOCKED, which is input to the processing circuitry. For example, the DOOR UNLOCKED signal may be an interrupt to a microprocessor that will cause it to enter certain processing routines as further described. Thus, the transition of the bolt from a retracted state (unlocked) to an extended state (locked) is communicated to the processor, as is the transition of the bolt from an extended state (locked) to a retracted state (unlocked). Other types of position detecting mechanisms may be used to detect the position of the bolt in addition to the contact switch embodiment described therein, such as a magnetic reed switch, optical detectors, etc.

In addition, the sensor 6 may be a standard door contact switch 6b as known in the art.

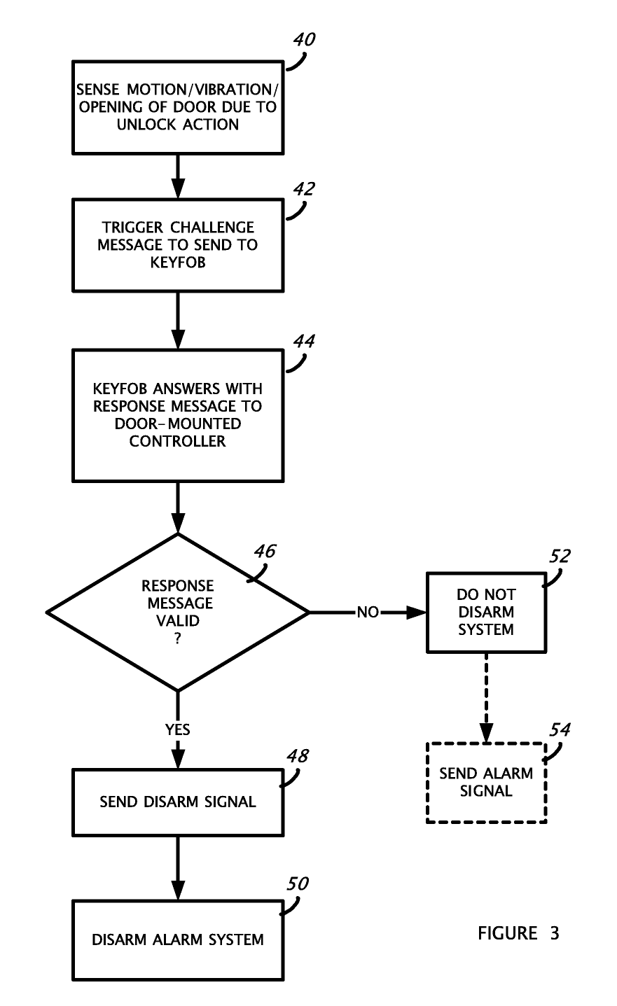

Thus, with further reference to the flowchart of FIG. 3, the sensor 6 will detect a predetermined event, such as change in position of the door, vibration of the door, opening of the lock, proximity of the keyfob processing unit, etc., as described above, and then generate a TRIGGER signal 14 (step 40) as shown in FIG. 1. On receipt of the TRIGGER signal 14, the keyfob interrogation processing unit 8 is triggered and a challenge signal 16 is wirelessly transmitted (step 42). The keyfob processing unit 4 receives the challenge signal 16 and, if appropriately coded, will generate a response message 18 containing an authorization code (step 44). The response message 18 will be received by the keyfob interrogation unit 8 and analyzed to ensure that the keyfob processing unit 4 is authorized (step 46). For example, a lookup table 28 (see FIG. 2) may be used to store a number of authorized keyfob processing unit serial numbers or other unique identifiers, such that an unauthorized keyfob processing unit 4 will not be recognized by the keyfob interrogation unit 8. Other methods of secure communications such as encryption, hashing etc. may be used to ensure that the challenge and response messages provide a secure communications between the keyfob interrogation unite 8 and the keyfob processing unit 4. In addition the effective range of communications between these two devices is purposefully kept small, such as in the range of 1 meter.

When the keyfob interrogation unit receives a response message and decodes the identifier, and then determines that the response was received from an authorized keyfob processing unit, then a disarm signal 20 is generated by the alarm system disarm unit 10, which operates in association with the keyfob interrogation unit 8. The disarm signal 20 is sent (step 48) and received by the alarm system 12 and the alarm system is accordingly disarmed (step 50). In the event that the keyfob interrogation provided a result that indicated the absence of an authorized keyfob, then the system would have to be disarmed manually by the homeowner (step 52). In the alternative, an alarm signal could be sent (step 54) immediately in the event that the response message analysis indicates that the keyfob is not authorized, or if no valid response message is received after a predetermined timeout period has expired.

As a result, a homeowner may keep the keyfob processing unit in his pocket, or on a keychain, and the alarm system will be automatically disarmed as the door is unlocked.

The preferred embodiment of the present invention is now described in further detail with respect to FIG. 2. As shown, any of the sensors 6a, 6b, or 6c as described above may be used to generate the trigger signal 14. The system may be configured with more than one of these sensors, wherein activation of any of the sensors 6 would generate a trigger 14, or it could require all of the sensors to activate the trigger 14, etc. For example, it may be desired to ensure the person has opened the door after unlocking it, and then passively disarm the system. This would guard against disarming the system only when the door is unlocked but not opened, such as if the person changes his mind and decide re-lock the door rather than entering the premises (which would leave the premises in a disarmed state). Likewise, a sensor may detect that a person has entered the immediate region of the door (such as with a PIR), unlocked and opened the door, and then trigger the invention with trigger signal 14.

Once the trigger signal 14 has been generated, it will cause the challenge logic 22 to generate and transmit an appropriate challenge message 16. This message may contain a coded signal that can be received and interpreted by the keyfob processing unit 4. The keyfob will return a response message 18, which will be a predetermined coded signal as known in the art. The response message 18 has the authorized code embedded therein, and is received by the response logic 26. The coded message is then extracted from the signal and compared to a lookup table 28, which contains a list of registered keyfob identification numbers (e.g. serial numbers) that have been previously stored (“learned”) as known in the art of security system installations. FIG. 2 shows three different authorized codes, but any given installation may have only one code or more codes than shown. Compare logic 30 will then compare the response data 26 with the lookup table data 28 and look for a match. If there is a match, meaning the keyfob 4 has been previously registered and is authorized, then a VALID signal is generated and causes the transmit disarm logic 34 to transmit a DISARM signal to the alarm system control panel, thus disarming the system. If, however, there is no match, then a NOT VALID signal is generated. This may then cause the transmit alarm logic 36 to transmit an ALARM message to the alarm system control panel. Generation of the ALARM message is optional and may be omitted if desired by the system designer and/or installer. That is, it may be desired to only leave the alarm system armed if the keyfob does not succeed in passively disarming the alarm system, and then require the homeowner to manually disarm the system upon entering as in the prior art. Or, if increased security is desired, the failure of a valid keyfob response could affirmatively and immediately activate the alarm as described.

In an alternative embodiment, a timeout counter 24 could be used to generate an alarm timeout signal 25 and cause the system to alarm. In this case, the issuance of the challenge message 16 would initiate the timeout counter 24. If no response 18 is received by the time the counter 24 expires, then the alarm timeout signal 25 would be generated. That is, receipt of a response message clears or resets the timeout counter 24. In the alternative, the system designed could require that the only the receipt of a valid response message may be used to reset the timeout counter 24.

In the alternative to using the preregistered codes in the lookup table 28 to verify the authenticity of the keyfob 4, a predefined algorithm such as a hashing function may be implemented. In this case hash logic 32 operates on the received response data 26. If the hash function provides a true result, then the disarm signal is generated, and if the hash function provides a false result (unauthorized response code) then the alarm signal may be generated.

As a further option, the present invention may be implemented without using a challenge query, wherein the keyfob would periodically transmit the response data 18. In this embodiment, however, more power is consumed since the keyfob is continuously transmitting signals. It would be preferred (although not required) that the keyfob be in a sleep mode that is woken from by the receipt of the triggered challenge message 16 as described above.

In a further embodiment, the keyfob processing unit 4 may engage with the sensor 6 merely by being in close proximity (such as a magnetic field sensor) at which point the keyfob processing unit 4 may transmit a coded message 18 that is processed as described above, or the keyfob interrogation unit 8 may issue a challenge message 16 as described above. Thus, the present invention may work with a mechanical trigger that is sensed by sensor 6 or use proximity sensors such as with a magnetic field.

In a further embodiment, the physical installation of the devices mentioned above is considered. It is desired to install the components of this invention in a simple manner so as to avoid extensive modifications to existing structures such as doors and locks. Here, the wireless processing unit is fabricated as part of a small flexible material that may be mounted on a standard key, such as on the top round section of the key. Miniaturization of components allows for a small flexible circuit that may be so mounted. This may therefore be useful in this manner to retrofit an existing key so that a special keyfob may not be required.

In addition, although the door-mounted controller in part or in whole may be adapted to be mounted within a door cavity or doorjamb cavity, the electronic components described above (which may be microprocessors and/or hybrid type circuits, ASICs etc.) may be implemented in a small housing that may be mounted on the narrow part of the door lock, such as on a flexible material strip or the like. This would be preferably located on the inside of the door so as to avoid tampering by an intruder if it were located on the outside of the door. The circuitry may also be located in a small housing that may hang from the doorknob on the inside and secured accordingly. In this embodiment, it may be desired to implement a wireless door contact switch or the like so the keyfob interrogation unit 8 may be wirelessly triggered when the door is opened as previously described. Or, it may be desired to omit the challenge part of the device and simply have the wireless processing unit transmit the response message periodically, or if sensed to be in proximity to the door-mounted controller, as desired.

What is claimed is:

1. A method of disarming an alarm system in a premises comprising:
a) detecting motion of at least part of a door in the premises to trigger generation of a challenge signal;
b) transmitting the challenge signal;
c) receiving a response signal;
d) determining if the response signal is valid as having been generated by an authorized disarm device; and
e) if the response signal is valid, then transmitting a disarm message effective to cause the alarm system to become disarmed.

2. The method of claim 1 further comprising
f) if the response signal is not valid, then transmitting an alarm message effective to cause the alarm system to generate an alarm.

3. The method of claim 1 further comprising
f) if no valid response signal is received after a predetermined time has elapsed, then transmitting an alarm message effective to cause the alarm system to generate an alarm.

4. The method of claim 1 wherein detecting motion of at least part of a door in the premises comprises detecting said motion with an accelerometer device mounted in the door.

5. The method of claim 1 wherein detecting motion of at least part of a door in the premises comprises detecting if the door has been at least partially opened with a door contact switch.

6. The method of claim 1 wherein detecting motion of at least part of a door in the premises comprises detecting if a lock mechanism mounted in the door has been retracted from a locked position.

7. The method of claim 1 wherein determining if the response signal is valid as having been generated by an authorized disarm device comprises
(i) extracting response data from the response signal;
(ii) comparing the extracted response data with at least one entry in a previously stored lookup table; and
(iii) declaring the response signal to be valid if the extracted response data matches at least one entry in the previously stored lookup table.

8. The method of claim 1 wherein determining if the response signal is valid as having been generated by an authorized disarm device comprises
(i) extracting response data from the response signal;
(ii) performing an algorithm on the extracted response data to generate an algorithm result; and
(iii) declaring the response signal to be valid if the algorithm result is true.

9. A device for passively disarming an alarm system comprising:
a) a portable wireless disarm device comprising processing circuitry adapted to transmit a response signal on receipt of a challenge signal; and
b) a door-mounted controller, comprising:
i) a door motion detector that generates a trigger signal on detecting motion of a door to which the door-mounted controller is mounted; and
ii) a processing unit coupled to the door motion detector that:
wirelessly transmits a challenge signal as a result of the trigger signal from the door motion detector,
receives a response signal from the disarm device,
determines if the response signal is valid; and
if the response signal is valid, generates and transmits a disarm message effective to cause the alarm system to become disarmed.

10. The device of claim 9 wherein, if the response signal is not valid, the processing unit is further adapted to transmit an alarm message effective to cause the alarm system to generate an alarm.

11. The device of claim 9 wherein, if no valid response signal is received after a predetermined time has elapsed, the processing unit is further adapted to transmit an alarm message effective to cause the alarm system to generate an alarm.

12. The device of claim 9 wherein the door motion detector is an accelerometer.

13. The device of claim 9 wherein the door motion detector is a door contact switch.

14. The device of claim 9 wherein the door motion detector is a lock position detector.

15. The device of claim 9 wherein the processing unit determines if the response signal is valid by:
(i) extracting response data from the response signal;
(ii) comparing the extracted response data with at least one entry in a previously stored lookup table; and
(iii) declaring the response signal to be valid if the extracted response data matches at least one entry in the previously stored lookup table.

16. The device of claim 9 wherein the processing unit determines if the response signal is valid by:
(i) extracting response data from the response signal;
(ii) performing an algorithm on the extracted response data to generate an algorithm result; and
(iii) declaring the response signal to be valid if the algorithm result is true.

17. A processing unit for passively disarming an alarm system, the processing unit adapted to interface to an external door motion detector that generates a trigger signal on detecting motion of a door to which the door-mounted controller is mounted, wherein the processing unit is configured to:
wirelessly transmit a challenge signal as a result of the trigger signal from the door motion detector,
receive a response signal from an external disarm device,
determine if the response signal is valid; and
generate and transmit a disarm message effective to cause the alarm system to become disarmed.

18. The device of claim 9 wherein the door-mounted controller is mounted in a housing adapted to be mounted on the outside of a door.
